(19) United States
(12) Patent Application Publication
(10) Pub. No.: US 2006/0010367 A1
(43) Pub. Date: Jan. 12, 2006

(54) System and method for spreadsheet data integration

(76) Inventors: Juergen Sattler, Wiesloch (DE); Joachim Gaffga, Wiesloch (DE)

Correspondence Address: KENYON & KENYON, 1500 K. STREET N.W., SUITE 700, WASHINGTON, DC, 20005, US

(21) Appl. No.: 11/177,325

(22) Filed: Jul. 11, 2005

Related U.S. Application Data
(63) Continuation-in-part of application No. 11/026,051, filed on Jan. 3, 2005.
(60) Provisional application No. 60/619,718, filed on Oct. 19, 2004.
(60) Provisional application No. 60/586,233, filed on Jul. 9, 2004.
(60) Provisional application No. 60/586,234, filed on Jul. 9, 2004.
(60) Provisional application No. 60/620,682, filed on Oct. 22, 2004.

(51) Int. Cl. G06F 15/00; G06F 17/30; G06F 17/00

(52) U.S. Cl. 715/503; 707/1; 707/3; 715/764

(57) ABSTRACT

A system and method for integrating data into a spreadsheet. According to one embodiment, a spreadsheet application provides authentication information to a data server by a spreadsheet application, the authentication information pertaining to a user of the spreadsheet application, receives query formulation data from the data server upon approval of the authentication information, the query formulation data provided in accordance with an authorization level determined by the data server to be assigned to the user, displays the query formulation data via a spreadsheet application user interface provided by the spreadsheet application, receives a query request from the user based on the query formulation data, provides the query request to the data server, receives a first data set as a result of the query request from the data server, and displays the first data set in a spreadsheet via the spreadsheet application user interface.

### CROSS REFERENCE TO RELATED APPLICATIONS

This application claims the benefit under 35 U.S.C. § 119(e) of U.S. Provisional Application No. 60/619,718, filed Oct. 19, 2004. This application also is a continuation-in-part of U.S. patent application Ser. No. 11/026,051, filed Jan. 3, 2005, which claims the benefit under 35 U.S.C. § 119(e) of U.S. Provisional Application Nos. 60/586,233 and 60/586,234, both filed Jul. 9, 2004, and U.S. Provisional Application No. 60/620,682, filed Oct. 22, 2004.

### BACKGROUND OF THE INVENTION

It is common for sets of data to be stored in a computer system so that the data may be searched and/or retrieved by a user. For example, a database may store a collection of records that a user may search using a database management system. As another example, a customer relationship management (“CRM”) system or other business information system may contain collections of data objects that may be retrieved by a user.

It is also common for computer users to frequently employ spreadsheet application software programs, such as Microsoft Excel®, Lotus 1-2-3®, etc., to operate upon data values. Spreadsheet programs let users create and manipulate electronic spreadsheets, which may contain a table of values arranged in rows and columns and having a predefined relationship to the other values.

However, no current solution allows users to seamlessly search, retrieve and interact with data, to the extend that each of the aforementioned solutions individually provide, in one environment.

Accordingly, the present inventors perceive a need in the art for an integrated work environment that combines the benefits of data set search and retrieval found in database management and business information systems with the data operability found in spreadsheet programs.

### BRIEF DESCRIPTION OF THE DRAWINGS

FIG. 1 is a block diagram that depicts a user computer system and back-end database in accordance with an embodiment of the present invention.

FIG. 2 is a block diagram that depicts representations of a spreadsheet user interface in accordance with an embodiment of the present invention.

FIG. 3 is a block diagram that depicts a system architecture in accordance with an embodiment of the present invention.

FIG. 4 is a process flow diagram that depicts an authentication and query presentation process in accordance with an embodiment of the present invention.

FIG. 5 is a process flow diagram that depicts a query process in accordance with an embodiment of the present invention.

FIG. 6 is a block diagram that depicts generation of a spreadsheet file from back-end system data in accordance with an embodiment of the present invention.

FIG. 7 is a process flow diagram that depicts a refresh process in accordance with an embodiment of the present invention.

FIG. 8 is a process flow diagram that depicts an upload process in accordance with an embodiment of the present invention.

FIG. 9 is a block diagram that depicts a computing device in accordance with an embodiment of the present invention.

### DETAILED DESCRIPTION

The present invention addresses the current drawbacks in known systems by allowing users of a spreadsheet program to log in to and query external data sets from within the spreadsheet program environment, and to have the corresponding search results be imported into the spreadsheet program. The imported results can then be saved locally or in a document management system, modified and passed around while still retaining its association with the external data sets.

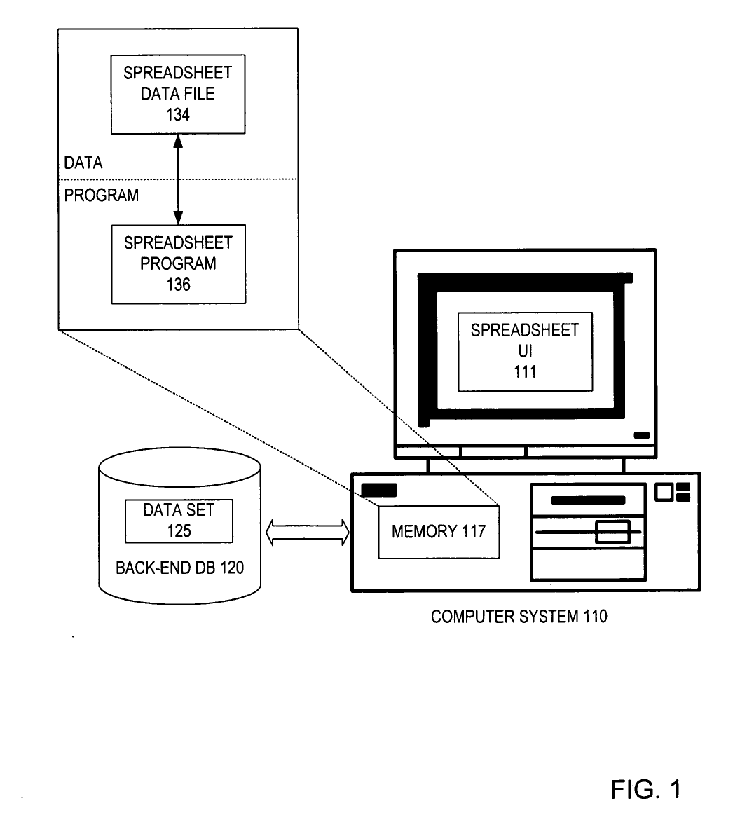

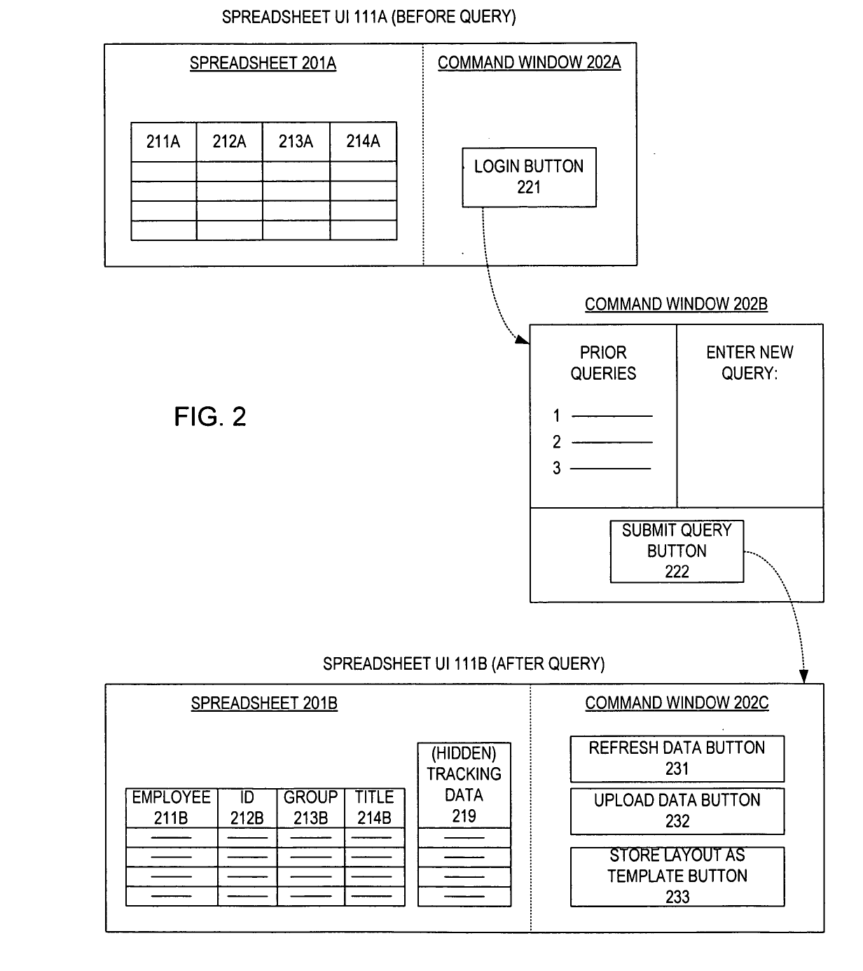

FIGS. 1 and 2 illustrate an embodiment of the present invention in which a user interacts with the user interface (111) of a spreadsheet program (136) on computer system 110 to search, retrieve and operate on data from a data set (125) in a back-end database (120).

As shown in FIG. 1, the spreadsheet program (136) allows the user, through its user interface (111), to log in and query a data set (125) in a back-end system, which then generates a spreadsheet data file (134) with the results of the query for display through the spreadsheet user interface (111). Both the spreadsheet program (1136) and the spreadsheet data file 134) may be resident in a memory (117) of the computer system (110) at runtime.

FIG. 2 shows a representation of the user interface (111) before, during and after a query in accordance with an embodiment of the invention. A user interface (111) may include two sections: a spreadsheet (201) and a command window (202). The spreadsheet section (210) comprises the traditional grid structure in which rows and columns of data may be presented and manipulated by the user, while the command window (202) may allow the spreadsheet program (136) to provide the user with additional information and functionality for interacting with the data.

Prior to a query being executed in this embodiment, the spreadsheet section (201A) of the user interface (111A) includes empty fields (211A, 212A, 213A, 214A) and a command window (202A) presenting the user with a login button (221). Upon pressing the login button (221) and providing login information, if authenticated the user may be presented in the command window (202B) with data from which the user may formulate a query, such as prior queries submitted by the user and a navigation area (e.g., a hierarchical visualization based on particular business processes) within which the user can enter a new query. The command window (202B) may also display a submit query button (222) for the user to press once a query has been selected or entered.

After the query request is submitted to the back-end, the spreadsheet user interface (111B) may then display the data set resulting from the query request in the spreadsheet section (201B). The resulting data set may include, for example, fields for employee names (211B), employee IDs (212B), employee groups (213B), and employee titles (214B). The spreadsheet data file 134 may also contain hidden data (219), or metadata, that is not displayed by the spreadsheet program (136) that is used to track the changes in the data and map the spreadsheet entries with the original data set in the back-end.

The command window (202C) may also present the user with buttons to refresh the spreadsheet data with the current back-end data set values (231), to upload modified spreadsheet data values into the back-end (232), and to store the current spreadsheet layout (e.g., the arrangement/formatting of columns) as a template for a future spreadsheet (233).

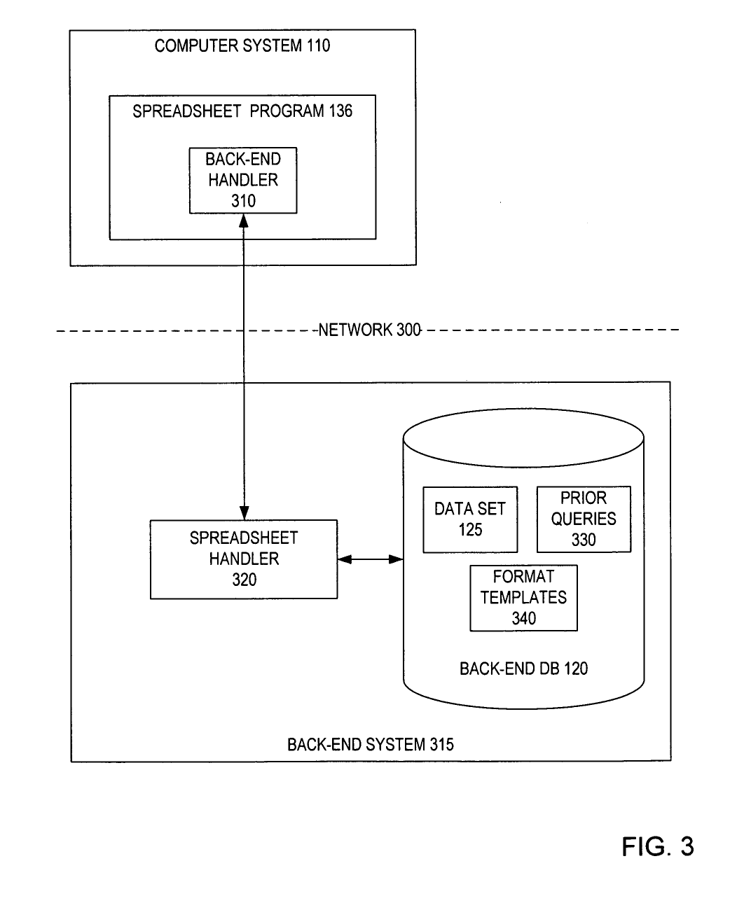

FIG. 3 depicts a system architecture that supports embodiments of the present invention. The spreadsheet program (136) running on the user computer system (110) may include a back-end handler module (310) that provides the front-end functionality of the present invention such as, for example, communicating requests across a network (300) to the back-end system (315) and providing a presentation layer for login and data operations. The back-end handler module (310) may comprise, for example, an extension to a known spreadsheet application, such as a DLL for Microsoft Excel®. The back-end system (315), which may also be considered a data server, may include a spreadsheet handler (320) that provides the back-end functionality of the present invention such as, for example, responding to requests from the computer system (110) and back-end data management with a back-end database (120). The back-end database (120) may include a data set (125) to be queried by the spreadsheet user, a list of prior queries associated with each user (330) from which the user may formulate a new query, and spreadsheet format templates (340) that may be used to provide a pre-defined layout in the spreadsheet for the display of queried data.

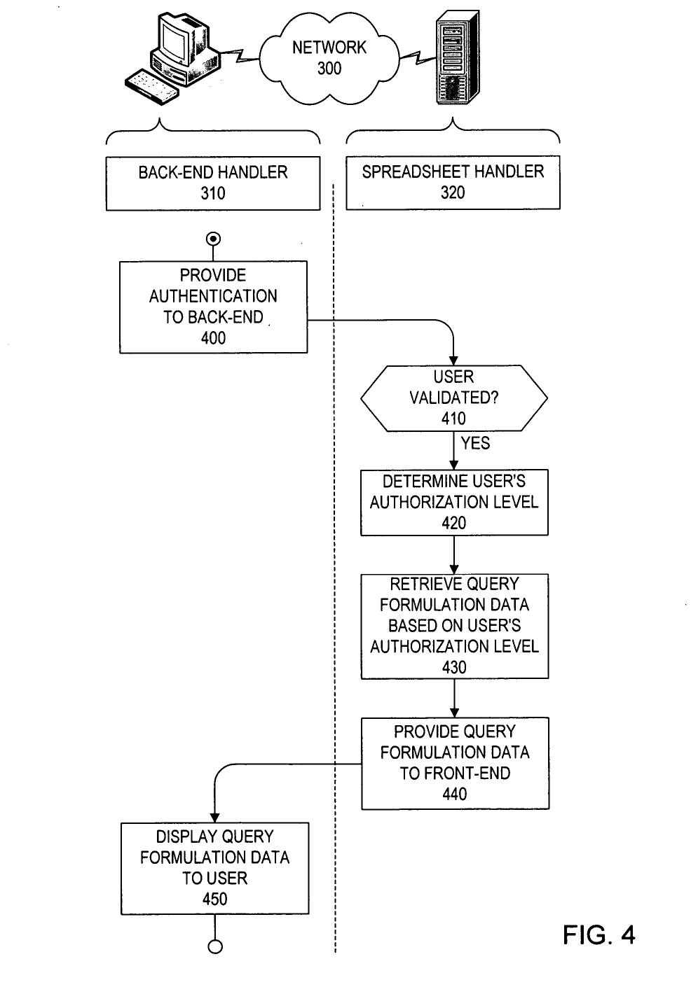

FIG. 4 depicts an authentication and query presentation process in accordance with an embodiment of the present invention. When a user wishes to retrieve data from the back-end system (315) to be imported into a spreadsheet, the user may press a login button (221) in a command window (202A) of the spreadsheet program (136), which may invoke a prompt for login information from the user such as a username and password. Once the back-end handler (310) receives the login request information from the user, it provides the information to the spreadsheet handler (320) for authentication (step 400). (Other authentication mechanisms, such as a single sign-on protocol, for example, may also be utilized in embodiments of the present invention.) Once the spreadsheet handler (320) receives the authentication information, it determines if the user is allowed to access the back-end system (315) (step 410), and if so, determines an authorization level associated with the user (step 420). Upon making this determination, it retrieves query formulation data in accordance with the user's authorization level (step 430). The spreadsheet handler (320) then provides the retrieved query formulation data to the back-end handler (310) (step 440), which displays the query formulation data to the user in the command window (202B) (step 450).

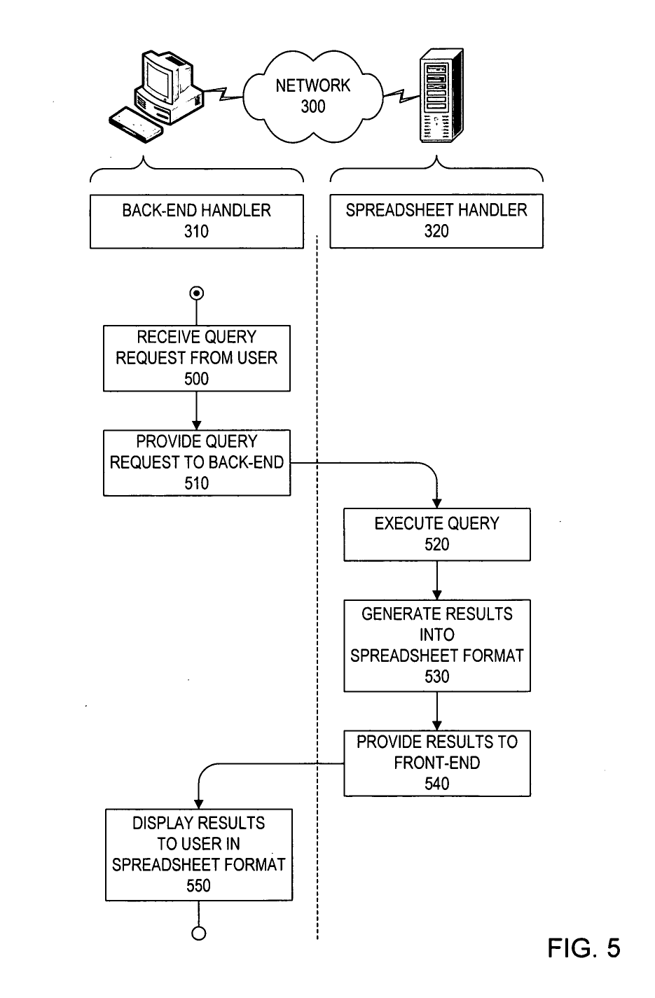

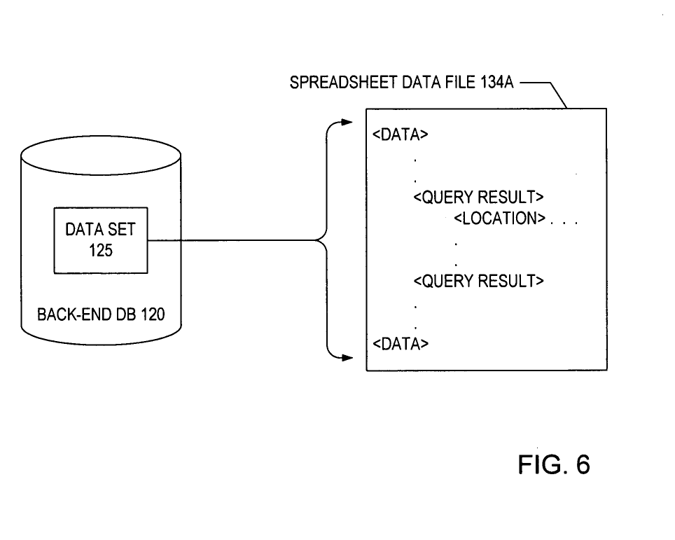

FIG. 5 depicts a subsequent query process in accordance with an embodiment of the present invention. Once the back-end handler (310) receives the query request from the user (e.g., a query selected or entered by the user in the command window (202B)) (step 500), it provides the query request to the spreadsheet handler (320) (step 510), which then executes the query at the back-end database (120) (step 520). The spreadsheet handler (320) then generates the resulting data set into a format recognizable by the spreadsheet program (136) (step 530) as shown in FIG. 6, for example. The resulting spreadsheet data file (134) is then provided to the back-end handler (310) (step 540) for display to the user (step 550) through the spreadsheet user interface (111B).

FIG. 6 depicts the generation of query results from the back-end database (120) into a spreadsheet data file (134A) in accordance with an embodiment of the present invention. Once the spreadsheet handler (320) receives the data set resulting from an executed query, it may generate an XML schema definition for the resulting data elements and an XML data structure to hold the resulting data elements. A pre-defined style sheet, tailored to an import format for the particular type of spreadsheet program (136) used by the user, may be merged with the schema definition via an XSL transformation to create a resulting style sheet, which then may be merged with the XML data structure via another XSL transformation to create the final spreadsheet data file (134A) (e.g., in the SpreadsheetML format).

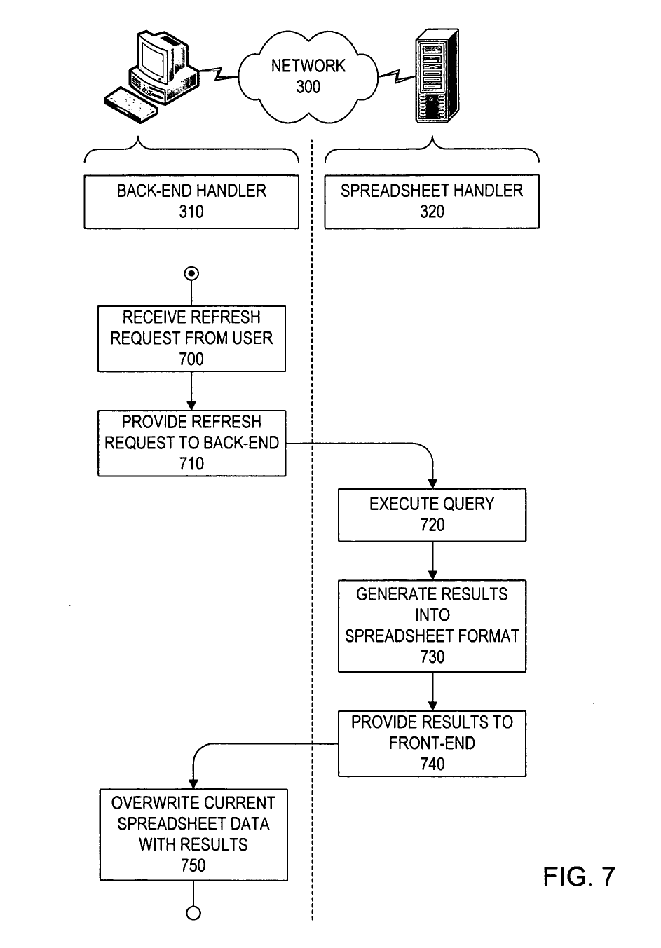

FIG. 7 depicts a refresh process in accordance with an embodiment of the present invention. This process is similar to the query process of FIG. 5, in that the back-end handler (310) asks the spreadsheet handler (320) to perform an updated query so that any values in the resulting data set that have changed since the prior query was executed can be reflected in the user's spreadsheet.

Once the back-end handler (310) receives the refresh request from the user (step 700), it provides the refresh request to the spreadsheet handler (320) (step 710), which then executes the same query as before at the back-end database (120) (step 720). (The refresh request to the spreadsheet handler (320) may comprise either the actual prior query request, or simply an instruction for the spreadsheet handler (320) to execute the prior query request associated with the user stored in the prior queries table (330) of the back-end database (120)). The spreadsheet handler (320) then generates the resulting data set into a format recognizable by the spreadsheet program (136) (step 730) as shown in FIG. 6, for example. The resulting spreadsheet data file (134) is then provided to the back-end handler (310) (step 740) for display to the user (step 750) through the spreadsheet user interface (111B). The back-end handler (310) will overwrite any outdated data values in the spreadsheet with the corresponding updated values from the back-end database (120).

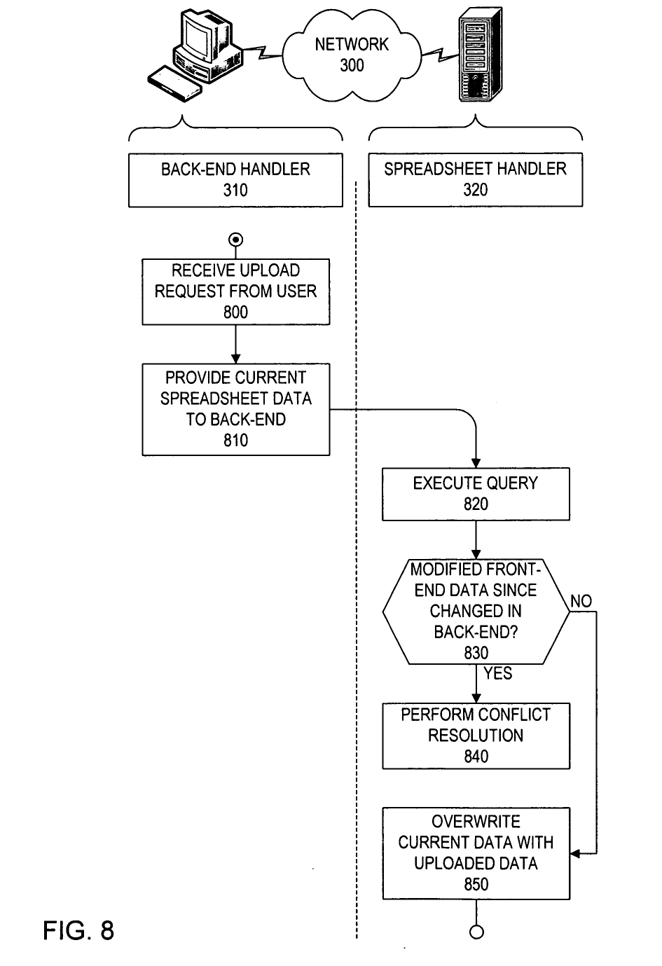

FIG. 8 depicts an upload process in accordance with an embodiment of the present invention. Upon receiving an upload request from the user (step 800), the back-end handler (310) provides the upload request to the spreadsheet handler (320) (step 810), which then executes the query associated with the uploaded data at the back-end database (120) (step 820). If the spreadsheet handler (320) determines that any of the back-end data corresponding to any modified uploaded data has changed since the back-end data was last provided to the back-end handler (310) (step 830), then a conflict exists (because the user has changed a value at the front-end while someone else has changed the corresponding value at the back-end) and a conflict resolution process is initiated (step 840). If the spreadsheet handler (320) determines that no back-end data corresponding to any modified uploaded data has changed since the back-end data was last provided to the back-end handler (310), then the back-end data is overwritten with the modified uploaded data (step 850).

The determination in step 830 may be made if the spreadsheet data file (134) includes the last version of data provided by the spreadsheet handler (320) as hidden data (219) in addition to the local version that is modified by the user at computer system 110. If these two version of the data are provided to the spreadsheet handler (320) with an upload request (step 810), then the spreadsheet handler (320) may compare the results of the query executed in step 820 with the last hidden version of data to determine whether any changes have occurred for corresponding data values both at the front-end and back-end. Also, if no conflict exists, the spreadsheet handler (320) may determine which values to update in step 850 by comparing the local version of the data with the last version.

In the event a conflict does exist (step 840), the spreadsheet handler (320) may institute a conflict resolution process that allows the user to view, in a line item manner for each conflicting value, both the front-end data value modified by the user and the corresponding back-end data value modified by someone else to determine which value is to be persisted in the back-end. This process may be implemented via a split screen window on computer system 110 or via the spreadsheet UI (111).

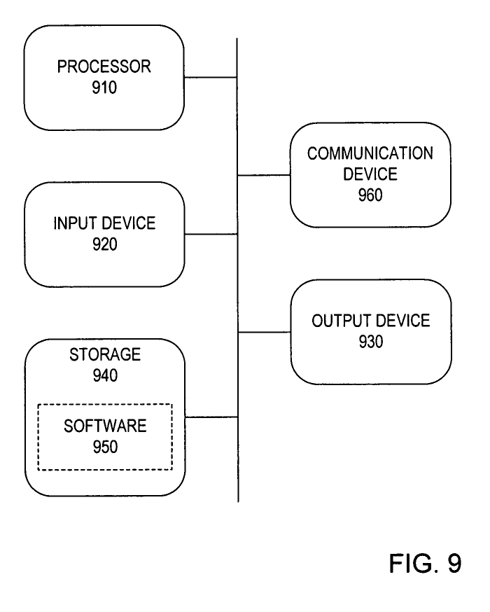

FIG. 9 illustrates the components of a basic computing device in accordance with an embodiment of the present invention, which may include computer system 110 and back-end system 315. The computing device may be a personal computer, workstation, handheld personal digital assistant (“PDA”), server, or any other type of microprocessor-based device. The computing device may include one or more of processor 910, input device 920, output device 930, storage 940, and communication device 960.

Input device 920 may include a keyboard, mouse, pen-operated touch screen or monitor, voice-recognition device, or any other device that provides input. Output device 930 may include a monitor, printer, disk drive, speakers, or any other device that provides output.

Storage 940 may include volatile and nonvolatile data storage, including one or more electrical, magnetic or optical memories such as a RAM, cache, hard drive, CD-ROM drive, tape drive or removable storage disk. Communication device 960 may include a modem, network interface card, or any other device capable of transmitting and receiving signals over a network. The components of the computing device may be connected via an electrical bus or wirelessly.

Software 950, which may be stored in storage 940 and executed by processor 910, may include, for example, the application programming that embodies the functionality of the present invention (e.g., as embodied in back-end handler 310 and spreadsheet handler 320). Software 950 may include a combination of enterprise servers such as an application server and a database server.

Network 300 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 950 may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention. For example, software modules that implement the present invention such as back-end handler 310 and spreadsheet handler 320 may comprise several discrete modules that together still provide the same functionality, data specified in back-end database 120 may be spread over several databases and/or systems, and the flow diagrams of FIGS. 4, 5, 7 and 8 may encompass several intermediate steps that do not detract from the higher level functionality described therein.

What is claimed is:

1. A computer-implemented method for integrating data into a spreadsheet, comprising:
providing authentication information to a data server by a spreadsheet application, the authentication information pertaining to a user of the spreadsheet application;
receiving query formulation data from the data server upon approval of the authentication information, the query formulation data provided in accordance with an authorization level determined by the data server to be assigned to the user;
displaying the query formulation data via a spreadsheet application user interface provided by the spreadsheet application;
receiving a query request from the user based on the query formulation data;
providing the query request to the data server;
receiving a first data set as a result of the query request from the data server; and
displaying the first data set in a spreadsheet via the spreadsheet application user interface.

2. The method of claim 1, wherein the authentication information is derived from a login request entered by the user via the spreadsheet application user interface, the login request including a username and password.

3. The method of claim 1, wherein the query formulation data includes previous queries associated with the user at the data server.

4. The method of claim 1, wherein the query formulation data includes navigation data for constructing a query, the navigation data including identifiers corresponding to database fields controlled by the data server.

5. The method of claim 1, wherein the query request includes an identification of one of the previous queries associated with the user at the data server.

6. The method of claim 4, wherein the query request includes a query constructed by the user based on the navigation data.

7. The method of claim 1, further comprising:
receiving a request from the user to refresh the first data set;
providing the refresh request to the data server;
receiving from the data server a second data set as a result of the refresh request, the second data set being an updated version of the first data set; and
displaying the updated version of the first data set in the spreadsheet via the spreadsheet application user interface.

8. The method of claim 7, wherein the refresh request includes the query request.

9. The method of claim 7, wherein the refresh request includes an instruction for the data server to execute the query request.

10. The method of claim 1, further comprising:
receiving a request from the user to upload modified portions of the first data set to the data server; and
providing current spreadsheet data to the data server.

11. The method of claim 10, wherein the current spreadsheet data includes the first data set along with a current data set including the modified portions of the first data set.

12. A computer-implemented method for integrating data into a spreadsheet, comprising:
receiving authentication information from a spreadsheet application on behalf of a user of the spreadsheet application;
determining an authorization level assigned to the user upon approval of the authentication information;
retrieving query formulation data in accordance with the authorization level assigned to the user;
providing the query formulation data to the spreadsheet application;
receiving a query request from the spreadsheet application based on the query formulation data;
executing a query associated with the query request; and
providing to the spreadsheet application a first data set as a result of the executed query.

13. The method of claim 12, further comprising:
generating the first data set into a format based on XML that is recognizable by the spreadsheet program.

14. The method of claim 12, further comprising:
receiving from the spreadsheet application a request to refresh the first data set;
executing a query associated with the refresh request; and
providing to the spreadsheet application a second data set as a result of the executed query, the second data set being an updated version of the first data set.

15. The method of claim 12, further comprising:
receiving from the spreadsheet application a request to upload modified portions of the first data set along with current spreadsheet data.

16. The method of claim 15, wherein the current spreadsheet data includes the first data set along with a current data set including the modified portions of the first data set.

17. The method of claim 15, further comprising:
determining whether a local version of any of the modified portions of the first data set have been changed since the first data set was provided to the spreadsheet application.

18. The method of claim 17, further comprising:
if a local version of any one of the modified portions of the first data set is determined not to have been changed since the first data set was provided to the spreadsheet application, storing the any one of the modified portions of the first data set.

19. The method of claim 17, further comprising:
if a local version of any one of the modified portions of the first data set is determined to have been changed since the first data set was provided to the spreadsheet application, initiating a conflict resolution process to resolve which version of the any one of the modified portions of the first data set should be stored.
